(19) United States
(12) Patent Application Publication
(10) Pub. No.: US 2011/0195281 A1
(43) Pub. Date: Aug. 11, 2011

(54) SECONDARY BATTERY

(75) Inventor: Youngcheol Jang, Yongin-si (KR)

(73) Assignee: SAMSUNG SDI CO., LTD., Yongin-si (KR)

(21) Appl. No.: 12/958,243

(22) Filed: Dec. 1, 2010

Related U.S. Application Data
(60) Provisional application No. 61/302,677, filed on Feb. 9, 2010.

(51) Int. Cl. H01M 10/42

(52) U.S. Cl. 429/7

(57) ABSTRACT

The secondary battery includes an electrode assembly, an outer case housing the electrode assembly, and a protective circuit module electrically connected to a first electrode tab and a second electrode tab that extend from the electrode assembly. The protective circuit module includes a circuit board including a first connecting pad and a second connecting pad that are connected to the first electrode tab and the second electrode tab, respectively. One of the first connecting pad and the second connecting pad is formed of a material including copper, and is embedded by a certain depth into the circuit board.

### CLAIM OF PRIORITY

This application makes reference to, incorporates the same herein, and claims all benefits accruing under 35 U.S.C. §119 from a provisional application earlier filed in the U.S. Patent & Trademark Office on 9 Feb. 2010 and there duly assigned Ser. No. 61/302,677.

### BACKGROUND OF THE INVENTION

1. Field of the Invention

Aspects of the present invention relate to a secondary battery.

2. Description of the Related Art

There has recently been active development, manufacture, and use of compact and lightweight electrical/electronic devices such as cellular phones, laptop computers, and camcorders. These portable electrical/electronic devices have built-in batteries that allow them to operate in locations that are not provided with a separate power supply.

The batteries employed in these portable devices include rechargeable secondary batteries. Lithium secondary batteries are widely used as these batteries. In particular, lithium secondary batteries are quickly gaining favor because their operating voltage of 3.6V is 3 times greater than nickel cadmium batteries or nickel hydrogen batteries, which have been widely used as power sources for portable electronic equipment, and because of their high energy density per unit weight.

Secondary batteries are largely provided with an electrode assembly that can be charged and discharged with electrical energy, and a protective circuit module that can control the charging and discharging of the electrode assembly.

The electrode assembly and the protective circuit module are connected with an electrode tab, and there is currently much research and development in progress on how to connect the electrode assembly and the protective circuit module without electrical loss.

### SUMMARY OF THE INVENTION

Aspects of the present invention provide a secondary battery provided with a protective circuit module, which is provided with a connecting pad capable of being easily coupled to an electrode tab extending from an electrode assembly.

Aspects of the present invention also provide a secondary battery in which contact resistance is minimized.

According to one or more embodiments of the present invention, there is provided an electrode assembly including an electrode assembly including a first electrode tab and a second electrode tab, a case housing the electrode assembly, and a protective circuit module. The protective circuit module includes a circuit board, a first connecting pad connected to the first electrode tab, and a second connecting pad connected to the second electrode tab. At least one of the first connecting pad and the second connecting pad is embedded into the circuit board at a predetermined depth.

The at least one of the first connecting pad and the second connecting pad may be formed of a material including copper.

The electrode assembly may include a first electrode, a second electrode, and a separator disposed between the first electrode and the second electrode. The separator insulates the first electrode from the second electrode. The first electrode tab may be connected to the first electrode, and the second electrode tab may be connected to the second electrode.

The first electrode tab may be formed of the same material as a first electrode collector of the first electrode. The first electrode collector of the first electrode may be formed of aluminum or an aluminum alloy.

The second electrode tab may be formed of the same material as a second electrode collector of the second electrode. The second electrode collector of the second electrode may be formed of copper or a copper alloy.

The first connecting pad may be formed of the same material as the first electrode tab. The first connecting pad may be formed of aluminum, an aluminum alloy, nickel, or a nickel alloy.

The second connecting pad may be formed of the same material as the second electrode tab. The second connecting pad may be formed of copper or a copper alloy.

The predetermined depth may be no less than about 0.2 mm and less than a thickness of the circuit board. The thickness of the circuit board may be about 0.8 mm.

A portion of the at least the one of the first connecting pad and the second connecting pad may protrude from a surface of the circuit board. A height of the protruding portion of the one of the first connecting pad and the second connecting pad may be equal to or less than 0.05 mm.

A thickness of the one of the first connecting pad and the second connecting pad may be about 0.2 mm to about 0.65 mm.

The first connecting pad may be formed of a material including aluminum, an aluminum alloy, nickel, or a nickel alloy. The second connecting pad may be formed of a material including copper.

Another of the first connecting pad and the second connecting pad may include a first plate, a second plate, and a bent portion formed between the first plate and the second plate. The first plate may be formed on a surface of the circuit board.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a secondary battery according to an embodiment.

FIG. 2 is an exploded perspective view of a secondary battery according to another embodiment.

FIG. 3 is a perspective view illustrating a protective circuit module of a secondary battery according to another embodiment.

FIG. 4 is a sectional view taken along line A-A′ of FIG. 3.

### DETAILED DESCRIPTION OF THE INVENTION

There has recently been active development, manufacture, and use of compact and lightweight electrical/electronic devices such as cellular phones, laptop computers, and camcorders. These portable electrical/electronic devices have built-in batteries that allow them to operate in locations that are not provided with a separate power supply. The batteries employed in these portable devices include rechargeable secondary batteries. Lithium secondary batteries are widely used as these batteries.

Example embodiments will now be described more fully hereinafter with reference to the accompanying drawings. Examples are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

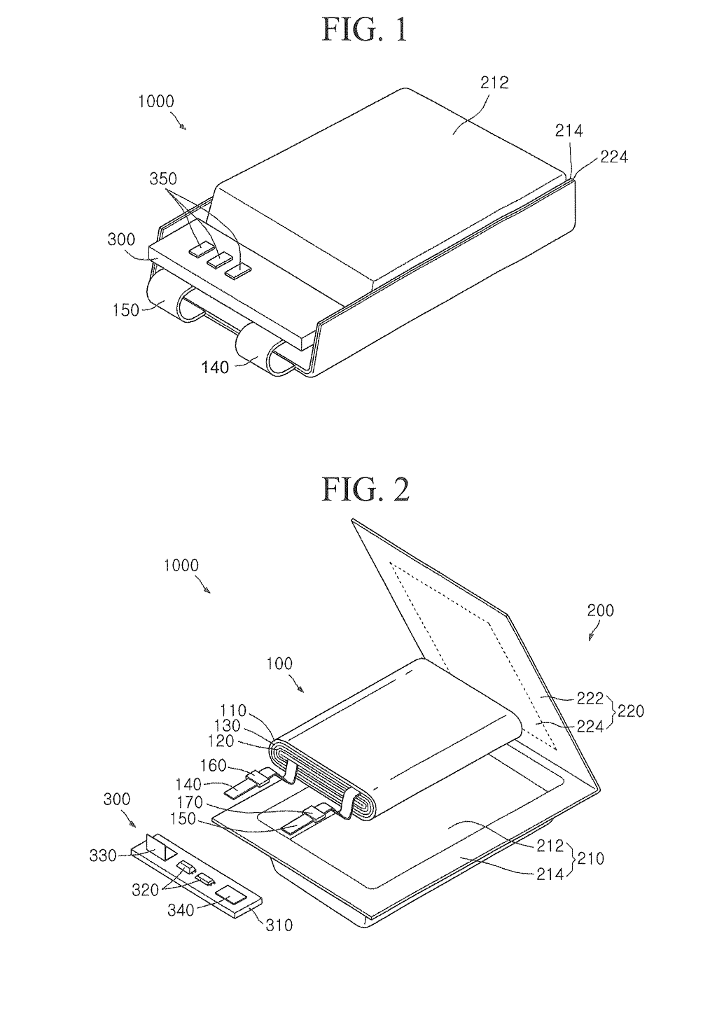

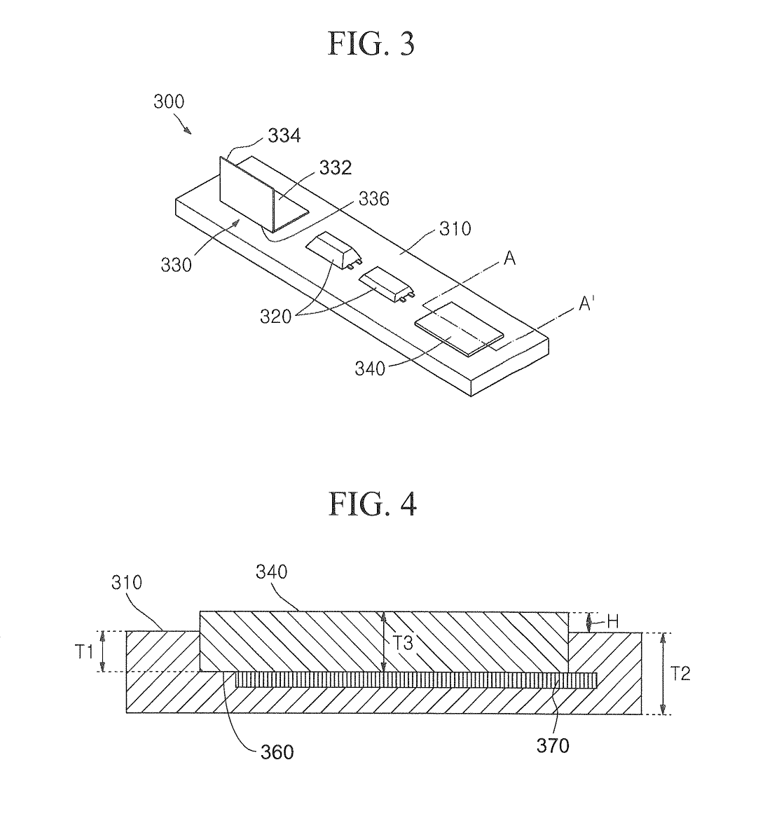

FIG. 1 is a perspective view of a secondary battery according to an embodiment, FIG. 2 is an exploded perspective view of a secondary battery according to another embodiment, FIG. 3 is a perspective view illustrating a protective circuit module of a secondary battery according to another embodiment, and FIG. 4 is a sectional view taken along line A-A′ of FIG. 3.

Referring to FIGS. 1 to 4, a description will be provided on a secondary battery according to an embodiment, where the secondary battery 1000 includes an electrode assembly 100, an outer case 200, and a protective circuit module 300.

The electrode assembly 100 includes a first electrode 110, a second electrode 120, a separator 130, a first electrode tab 140, and a second electrode tab 150. The first electrode 110 includes a first electrode collector and a first active material layer formed on the first electrode collector. The second electrode 120 includes a second electrode collector and a second active material layer formed on the second electrode collector.

Here, the first electrode 110 may be a positive pole, and the second electrode 120 may be a negative pole. Alternatively, the first electrode 110 may be a negative pole, and the second electrode 120 may be a positive pole. In one embodiment, for the sake of descriptive convenience, the first electrode 110 is presumed to be a positive pole, and the second electrode 120 is presumed to be a negative pole.

The first electrode collector of the first electrode 110 may be formed of aluminum or an aluminum alloy. Also, the second electrode collector of the second electrode 120 may be formed of copper or a copper alloy.

The first active material layer of the first electrode 110 may employ a chalcogenide composite material, and may employ, for example, composite metal oxide materials, such as LiCoO₂, LiMn₂O₄, LiNiO₂, LiNi₁₋ₓCoₓO₂ (0<x<1), LiMnO₂, etc.

The second active material layer of the second electrode 120 may employ a carbon (C)-based material, Si, Sn, tin oxide, composite tin alloys, transition metal oxides, lithium metal nitrides, lithium metal oxides, etc.

The separator 130 is interposed between the first electrode 110 and the second electrode 120, and functions to insulate the first electrode 110 and the second electrode 120. The separator 130 may employ PE (polyethylene) or PP (polypropylene).

The electrode assembly 100 includes a stack of the first electrode 110, second electrode 120, and the separator 130 providing insulation between the first electrode 110 and second electrode 120. The stack of the first electrode 100, separator 130, and the second electrode 120 is wound about an axis to form a jellyroll shape.

The first electrode tab 140 is connected to the first electrode collector of the first electrode 110, and extends out of the electrode assembly 100. The first electrode tab 140 may be formed of the same material of aluminum or aluminum alloy as the first electrode collector of the first electrode 110. Alternatively, the first electrode tab 140 may be formed of nickel or nickel alloy. The first electrode tab 140 may be integrally formed with the first electrode 110 and extend out of the electrode assembly 100, or may be attached on the first collector of the first electrode 110 and extend out of the electrode assembly 100.

A first insulating member 160 is disposed on the first electrode tab 140. As shown in FIG. 2, the first insulting member 160 may cover a portion of the first electrode tab 140. The first insulating member 160 protects the first electrode tab 140 when the outer case 200 is sealed.

The second electrode 150 is connected to the second electrode collector of the second electrode 120, and extends out of the electrode assembly 100. The second electrode tab 150 may be formed of the same material as the second electrode collector of the second electrode 120. That is, the second electrode tab 150 may be formed of a copper or copper alloy. Also, the second electrode tab 150 may be formed of a material that has favorable welding characteristics with a second connecting pad 340 to be described below. The second electrode tab 150 may be integrally formed with the second electrode 120 and extend out of the electrode assembly 100, or may be attached on the second electrode collector of the second electrode 120 and extend out of the electrode assembly 100.

A second insulting member 170 is disposed on the second electrode tab 150. The second insulting member 170 may cover a portion of the second electrode tab 150. The second insulating member 170 protects the second insulating tab 150 when the outer case 200 is sealed.

The outer case 200 may be a pouch type case. The outer case 200 may include a body 210 and a cover 220. The body 210 includes a receiving portion 212, which defines a space for housing the electrode assembly 100, and a sealing portion 214 expanded and extending from the entrance of the receiving portion 212.

The cover 220 extends from a perimeter of the sealing portion 214 of the body 210. The cover 220 covers all of the receiving portion 212 of the body 210 and is sealed with the sealing portion 214 of the body 210, and includes a receiving portion cover region 222 corresponding to the receiving portion 212 of the body 210, and a sealing portion 224 corresponding to the sealing portion 214 of the body 210.

Accordingly, in a secondary battery 1000 according to an embodiment, when the electrode assembly 100 is received in the receiving portion 212 of the body 210, the cover 220 is closed and sealed, and the sealing portion 214 of the body 210 and the sealing portion 224 of the cover 220 are sealed through a method such as thermal bonding.

Here, the first electrode tab 140 and the second electrode tab 150 are exposed outside the outer case 200.

The protective circuit module 300 includes a circuit board 310, devices 320 provided on a surface of the circuit board 310, a first connecting pad 330, and a second connecting pad 340. Also, the protective circuit module 300 includes outer terminals 350, which is formed on the other surface of the protective circuit module 300 and electrically connect the secondary battery 1000 to external devices.

The circuit board 310 is an insulating substrate. The circuit board 310 may include wires (not shown), which provides electrical connections among the devices 320 provided on the circuit board 310, the first connecting pad 330, the second connecting pad 340, and the outer terminals 350. The devices 320 may include IC devices that control the secondary battery 1000, and PTC devices that prevent excessive currents and control charging and discharging of the secondary battery 1000.

The first insulating pad 330 is connected to the first electrode tab 140. The first insulating pad 330 may be formed of a material including aluminum, aluminum alloy, nickel, or nickel alloy. The first connecting pad 330 may be formed of the same material as the first electrode tab 140.

The first connecting pad 330 includes a first plate 332, a second plate 334, and a bent portion 336 that is provided between the first plate 332 and the second plate 334. The first plate 332 is attached to the circuit board 310. Specifically the first plate 332 is attached to a wire formed on the circuit board 310.

The bent portion 336 is a portion of the first connecting pad 330, which connects the first plate 332 to the second plate 334 and is bent to make the second plate 334 face the first plate 332. Accordingly, in this structure of the first connecting pad 330, when an end of the first connecting tab 140 is disposed on the first plate 332, the first connecting pad 330 is bent with the second plate 334 facing the first plate 332 to form a stack in the order of the first plate 332, the end of the first connecting tab 140, and the second plate 334. Then, the first plate 332, the end of the first connecting tab 140, and the second plate 334 are coupled together. Therefore, the first connecting pad 330 is connected to the first connecting tab 140. Here, coupling of the first plate 332, the end of the first connecting tab 140, and the second plate 334 may be achieved through welding such as resistance welding.

The second connecting pad 340 is connected to the second electrode tab 150. The second connecting pad 340 may be formed of a material including copper or copper alloy. Therefore, the second connecting pad 340 may be a copper pad formed of copper or copper alloy.

The second connecting pad 340 is embedded in the circuit board 310. As shown in FIG. 4, a recess 360, having a predetermined depth, is formed on a surface of the circuit board 310, and the second connecting pad 340 is inserted into the recess 360 of the circuit board 310. A land 370 is formed on the surface of the recess 360. The land 370 may be a portion of one of wires of the circuit board 310, which provides electrical connections among the devices 320 formed on the circuit board 310 and the outer terminals 350. In FIG. 4, the land 370 is illustrated as formed on the bottom surface of the recess 360 for an example, but the location and shape of the land 370 are not limited to those shown in FIG. 4. The second connecting pad 340 can be electrically coupled to devices 320 and/or outer terminals 350 through the land 370. The second connecting pad 340 contacts the land 370, and electricity supplied from through the second electrode tab 150 is supplied to the land 370 through the second connecting pad 340. The land may be connected to some of the devices 320 or outer terminals 350 through wires in the circuit board 310.

The second connecting pad 340 is embedded into the circuit board 310 by an embedded depth T1, which is at least about 0.2 mm. in other words, the embedded depth T1 is no less than 0.2 mm. The reason that the embedded depth T1 of the second connecting pad 340 must be at least about 0.2 mm is that if the embedded depth of the second connecting pad 340 is too shallow, a detachment phenomenon between the second connecting pad 340 and the circuit board 310 can occur when the second connecting pad 340 and the second electrode tab 150 are connected. That is, when the second electrode tab 150 is mounted on the second connecting pad 340 using a surface mount technology (SMT), the minimum embedded depth T1 is about 0.2 mm in order to prevent the detachment phenomenon.

The second connecting pad 340 may be embedded with a depth T1 less than a depth T2 that is the thickness of the circuit board 310. That is, the second connecting pad 340 must be embedded so that it does not completely pass through the circuit board 310. In other words, the second connecting pad 340 is not exposed through the opposite surface of the circuit board 310. This is to prevent the second connecting pad 340 from being exposed at the opposite surface and contacting other devices.

In this embodiment, the circuit board 310 has a thickness T2 of about 0.8 mm. However, the circuit board 310 may be thicker or thinner than 0.8 mm depending on applications.

The second connecting pad 340 may protrude by a certain protruding height H from one surface of the circuit board 310. The protruding height H of the second connecting pad 340 is equal to or less than 0.05 mm. The second connecting pad 340 has a thickness T3 that is the sum of the embedded depth T1 of the second connecting pad 340 and the protruding height H. In the case that the thickness T2 of the circuit board is 0.8 mm, the thickness T3 of the second connecting pad 340 may be no less than 0.2 mm and preferably no greater than about 0.65 mm.

Accordingly, in a secondary battery 1000 according to an embodiment of the present invention, a protective circuit module 300 is provided having a first connecting pad 330 and a second connecting pad 340 connected to the first electrode tab 140 and second electrode tab 150, respectively, which extend from the electrode assembly 100. The first connecting pad 330 is easily connected to the first electrode tab 140 through the first plate 332 and the second plate 334 of the first connecting pad 330.

The second connecting pad 340 is provided as a copper pad, which is embedded by a certain depth into the circuit board 310 of the protective circuit module 300 and also projects by a certain height, in order to be easily connected to the second electrode tab 150. In particular, the first connecting pad 330 and the second connecting pad 340 are either formed of the same material as the first electrode tab 140 and the second electrode tab 150, respectively, or are formed of a material with good welding properties, so that the first connecting pad 330 and the second connecting pad 340 may easily be coupled to the first electrode tab 140 and the second electrode tab 150, respectively. Also, with a secondary battery 1000 according to an embodiment, by allowing easy coupling between the connecting pads and the electrode tabs, contact resistance can be minimized, and a reliable coupling structure can be provided.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A secondary battery comprising:
an electrode assembly including a first electrode tab and a second electrode tab;
a case housing the electrode assembly; and
a protective circuit module comprising:
a circuit board;
a first connecting pad connected to the first electrode tab; and
a second connecting pad connected to the second electrode tab, at least one of the first connecting pad and the second connecting pad being embedded into the circuit board at a predetermined depth.

2. The secondary battery of claim 1, wherein the at least one of the first connecting pad and the second connecting pad is formed of a material including copper.

3. The secondary battery of claim 1, wherein the electrode assembly comprises a first electrode, a second electrode, and a separator disposed between the first electrode and the second electrode, the separator insulating the first electrode from the second electrode, the first electrode tab being connected to the first electrode, the second electrode tab being connected to the second electrode.

4. The secondary battery of claim 3, wherein the first electrode tab is formed of the same material as a first electrode collector of the first electrode.

5. The secondary battery of claim 4, wherein the first electrode collector of the first electrode is formed of aluminum or an aluminum alloy.

6. The secondary battery of claim 3, wherein the second electrode tab is formed of the same material as a second electrode collector of the second electrode.

7. The secondary battery of claim 6, wherein the second electrode collector of the second electrode is formed of copper or a copper alloy.

8. The secondary battery of claim 1, wherein the first connecting pad is formed of the same material as the first electrode tab.

9. The secondary battery of claim 8, wherein the first connecting pad is formed of aluminum, an aluminum alloy, nickel, or a nickel alloy.

10. The secondary battery of claim 1, wherein the second connecting pad is formed of the same material as the second electrode tab.

11. The secondary battery of claim 10, wherein the second connecting pad is formed of copper or a copper alloy.

12. The secondary battery of claim 1, wherein the predetermined depth is no less than about 0.2 mm and less than a thickness of the circuit board.

13. The secondary battery of claim 12, wherein the thickness of the circuit board is about 0.8 mm.

14. The secondary battery of claim 1, wherein a portion of the at least the one of the first connecting pad and the second connecting pad protruding from a surface of the circuit board.

15. The secondary battery of claim 14, wherein a height of the protruding portion of the one of the first connecting pad and the second connecting pad is equal to or less than 0.05 mm.

16. The secondary battery of claim 1, wherein a thickness of the one of the first connecting pad and the second connecting pad is about 0.2 mm to about 0.65 mm.

17. The secondary battery of claim 1, wherein the first connecting pad is formed of a material including aluminum, an aluminum alloy, nickel, or a nickel alloy, the second connecting pad being formed of a material including copper.

18. The secondary battery of claim 1, wherein another of the first connecting pad and the second connecting pad includes a first plate, a second plate, and a bent portion formed between the first plate and the second plate, the first plate being formed on a surface of the circuit board.
